(19) United States
(12) Patent Application Publication
(10) Pub. No.: US 2024/0111368 A1
(43) Pub. Date: Apr. 4, 2024

(54) PRECISE NUMBER SELECTION IN ONE-HANDED OPERATIVE EQUIPMENT

(71) Applicant: Baker Hughes Holdings LLC, Houston, TX (US)

(72) Inventors: Daide Li, Shanghai (CN); Ralf Ratering, Hurth (DE); Jiamin Lei, Shanghai (CN)

(21) Appl. No.: 18/476,884

(22) Filed: Sep. 28, 2023

Related U.S. Application Data
(60) Provisional application No. 63/411,346, filed on Sep. 29, 2022.

(51) Int. Cl. G06F 3/02; G06F 3/0362

(52) U.S. Cl. CPC G06F 3/0202; G06F 3/0362

(57) ABSTRACT

An apparatus for performing non-destructive testing is provided. The apparatus includes a housing having a front face for displaying a user interface and a rear face. A plurality of first buttons is disposed on the rear face of the housing adjacent to a side face, and receives a first set of user inputs from a user. One or more second buttons are disposed on the housing and receive a second set of user inputs from the user. The first set of user inputs and the second set of user inputs are received via a forefinger and a thumb, respectively, of the user. The plurality of first buttons and the one or more second buttons are together configured to select a precise value of an operating parameter of the apparatus. Related methods of use are also described.

### RELATED APPLICATION

This application claims priority under 35 U.S.C. § 119(e) to U.S. Provisional Application No. 63/411,346 filed Sep. 29, 2022, the entire contents of which are hereby expressly incorporated by reference herein.

### BACKGROUND

Generally, one-handed operative instruments are used in the non-destructive testing field. In a one-handed operative equipment, selecting a desired number in a large range by a thumb of a user is difficult. Particularly, swiping back and forth is hard for selecting a precise number. In an example, a display range may be between 0.00 to 10000.00, and a user may feel depressed and foiled to select a number 4567.89. In some known systems, the one-handed operative equipment may include a rotary knob and the user may use the rotary knob to select the desired number. However, in a large range, the rotary knob can only be used for the coarse tune, and fine-tune is hard to be considered.

### SUMMARY

In one aspect of the present disclosure, an apparatus is provided. The apparatus can include a housing having a front face and a rear face. In some embodiments, the front face may be configured to display a user interface. The apparatus can include a plurality of first buttons disposed on the rear face of the housing adjacent to a side face, and configured to receive a first set of user inputs from a user. The apparatus can also include one or more second buttons configured to receive a second set of user inputs from the user. In some embodiments, the first set of user inputs and the second set of user inputs may be received via a forefinger and a thumb, respectively, of the user. In some embodiments, the plurality of first buttons and the one or more second buttons may be together configured to select a precise value of an operating parameter of the apparatus.

In another embodiments, the plurality of first buttons can include a first pair of buttons disposed on the rear face adjacent to a corner of the housing defined by the side face and a top face. In some embodiments, the first pair of buttons may be integrated into a first push button. In some embodiments, the plurality of first buttons can include a second pair of buttons disposed on the rear face adjacent to a corner of the housing defined by the side face and a bottom face.

In another embodiments, the second pair of buttons may be integrated into a second push button. In some embodiments, the one or more second buttons can include a third pair of buttons disposed on the front face of the housing. In some embodiments, the one or more second buttons can include a rotary knob disposed on the front face of the housing. In another embodiments, the one or more second buttons can include a virtual knob integrated within the user interface.

In some embodiments each of the plurality of first buttons may be configured to select a first bit in a number displayed on the user interface corresponding to a first click by the user and select an nth bit in the number corresponding to an nth click by the user. In some embodiments, the one or more second buttons may be configured to select a number between 0-9 after selecting the first bit or the nth bit in the number.

In another aspect a method is provided. The method can include receiving, via a plurality of first buttons provided on a one-handed operative NDT instrument, a first set of user inputs. In some embodiments, the one-handed operative NDT instrument can include a front face displaying a user interface and a rear face supporting the plurality of buttons.

In some embodiments, the plurality of buttons receives inputs from a forefinger of a user. In some embodiments the apparatus can include receiving, via one or more second buttons, a second set of user inputs upon receiving the first set of user inputs, to select a precise value of an operating parameter of the one-handed operative NDT instrument. In some embodiments, the one or more second buttons may be supported on the one-handed operative NDT instrument, and receive inputs from a thumb of the user.

In some embodiments, the plurality of first buttons can include a first pair of buttons disposed on the rear face adjacent to a corner of the housing defined by the side face and a top face of the one-handed operative NDT instrument. In some embodiments, the first pair of buttons may be integrated into a first push button.

In some embodiments, the plurality of first buttons can include a second pair of buttons disposed on the rear face adjacent to a corner of the housing defined by the side face and a bottom face of the one-handed operative NDT instrument. In some embodiments, the second pair of buttons may be integrated into a second push button.

In some embodiments, the one or more second buttons can include a third pair of buttons disposed on the front face of the housing. In some embodiments, the one or more second buttons can include a rotary knob disposed on the front face of the housing. In some embodiments, the one or more second buttons can include a virtual knob integrated within the user interface.

In some embodiments, the method can include selecting a first bit in a number displayed on the user interface corresponding to a first click by the user. In some embodiments the apparatus can include selecting an nth bit in the number corresponding to an nth click by the user. In some embodiments, the method can include, selecting, via the one or more second buttons, a number between 0-9 after selecting the first bit and/or the nth bit in the number.

Non-transitory computer program products (i.e., physically embodied computer program products) are also described that store instructions, which when executed by one or more processors of one or more computing systems, causes at least one processor to perform operations herein. Similarly, computer systems are also described that may include one or more processors and memory coupled to the one or more processors. The memory may temporarily or permanently store instructions that cause at least one processor to perform one or more of the operations described herein. In addition, methods can be implemented by one or more processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

For example, a one-handed operative equipment may include the one or more processors and memory soring instructions, which when executed by the processor causes the processor to perform the method. The instructions may cause the processor to perform an operation of receiving a first set of user inputs via a plurality of buttons of the one-handed operative equipment. The one-handed operative equipment can include a front face displaying a user interface and a rear face supporting the plurality of first buttons, which can receive inputs from a forefinger of a user.

The instructions may further cause the processor to perform an operation of receiving, via one or more second buttons, a second set of user inputs upon receiving the first set of user inputs to select a precise value of an operating parameter of the one-handed operative equipment. The one or more second buttons can be supported on the front face or a side face of the one-handed operative equipment or within the user interface, and receive inputs from a thumb of the user.

The instructions may further cause the processor to perform an operation of selecting a first bit in a number displayed on the user interface corresponding to a first click of the button by the user, and selecting an n^{th} bit in the number corresponding to an n^{th} click of the button by the user.

The instructions may further cause the processor to perform an operation of selecting, via the one or more second buttons, a number between 0-9 after selecting a bit in the number.

### DESCRIPTION OF DRAWINGS

These and other features will be more readily understood from the following detailed description taken in conjunction with the accompanying drawings, in which:

FIG. 1 is a front perspective view of an apparatus used for non-destructive testing, according to certain embodiments of the present disclosure;

FIG. 2 is a partial rear perspective view of the apparatus of FIG. 1, according to certain embodiments of the present disclosure;

FIG. 3 illustrates an actuation of a button of the apparatus using a forefinger of a user, according to certain embodiments of the present subject matter;

FIG. 4 illustrates an exemplary display page showing a value panel of a user interface of the apparatus and a block diagram illustrating a computing system associated with the user interface, according to certain embodiments of the present subject matter;

FIG. 5 illustrates exemplary images of the value panel of FIG. 4 showing selection of bits in a number, according to certain embodiments of the present subject matter;

FIG. 6 illustrates an exemplary display page showing a value panel of a user interface and an exemplary virtual knob within the user interface display of the apparatus of FIG. 1, which can be activated using, for example, a thumb of a user; and

FIG. 7 illustrates a flow diagram of a method of selecting numbers in the apparatus of FIG. 1, according to certain embodiments of the present subject matter.

It is noted that the drawings are not necessarily to scale. The drawings are intended to depict only typical aspects of the subject matter disclosed herein, and therefore should not be considered as limiting the scope of the disclosure.

### DETAILED DESCRIPTION

In a one-handed operative equipment, selecting a desired number in a large range is difficult with only a thumb swipe of a user. One-handed operative equipment can include diagnostic, monitoring, or testing equipment or instruments that are used for non-destructive testing of objects. One-handed operative equipment can be configured to be held and operated in a single hand of an operator. Thus one-handed operative equipment can be fully manipulated and operated without the need for an operator to use both hands. In some instruments, a rotary knob is provided such that the user can use the rotary knob to select a number associated with a parameter (e.g., a parameter value input) of the instrument. The rotary knob may be considered for coarse tuning and value selection in a large range, and may not be efficient for fine grained tuning or value selection. Therefore, the present subject matter discloses a solution to reduce effort of the user in selecting the desired number by providing physical buttons and making the process of selection of numbers easier.

According to the present disclosure, an easy way to select the desired number in the one-handed operative equipment is illustrated. The one-handed operative equipment is provided with one or more physical buttons to make the selection process of the desired numbers simple and efficient. Particularly, the selection of the desired number is achieved by selecting a number one bit by one bit to get the desired number. A bit can correspond to a value of a digit included in the number. For example, the number 321.04 can include 5 bits. A first bit can be digit value of “3”, a second bit can be a digit value of “2”, a third bit can be a digit value of “1”, a fourth bit can be a digit value of “0”, and a fifth bit can be a digit value of “4”. In some embodiments, the selected ordering of the bits can be reversed, such that the first bit can be the digit value of “4” and so on.

The physical buttons can be actuated by a forefinger of the user which makes the actuation of the physical buttons easy, which in turn reduces effort of the user. The one-handed operative equipment, according to the present disclosure, includes four physical buttons and the forefinger of the user will feel comfortable to click any one of the physical buttons provided on a left or right side of the equipment. The user may reuse the forefinger to click the physical button to select one bit in a number. When the physical button is clicked once, the first bit is selected, and when the physical button is clicked twice, the second bit is selected, and so on. Upon selection of one bit, the user may scroll the rotary knob to select an exact number between 0-9 only by thumb swipe. In some embodiments, the rotary knob can be a physical knob build in to the hardware of the one-handed operative equipment. In some embodiments, the rotary knob can be in the form of one or more physical buttons build in to the hardware of the one-handed operative equipment. In some embodiments, the rotary knob can be a virtual knob built into a user interface display of the one-handed operative equipment.

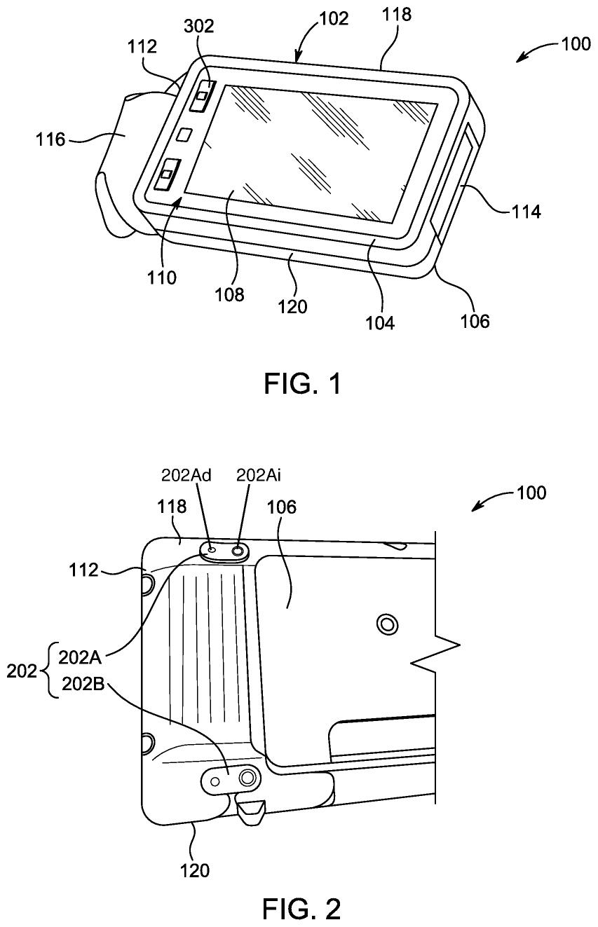

FIG. 1 illustrates an exemplary perspective view of an apparatus 100 used for performing non-destructive testing (NDT). The apparatus 100, according to the present disclosure, is a one-handed operative equipment which is generally held by one hand of a user while performing the NDT. The apparatus 100 includes a housing 102 having a front face 104 and a rear face 106. The front face 104 includes a display 108 and is configured to display a user interface (UI) 110. The housing 102 further includes multiple side faces, particularly, a left side face 112 and a right side face 114 extending between the front face 104 and the rear face 106. The apparatus 100 further includes a flexible handle 116 coupled to the left side face 112 of the housing 102 such that the user can comfortably and conveniently insert fingers through the flexible handle 116 to hold the apparatus 100 in a single hand of the user, for example the users left hand. The flexible handle 116 may be an adjustable strap or made of elastic material. One end of the flexible handle 116 is coupled to a top end of the left side face 112 and another end is coupled to a bottom end of the left side face 112. The right side face 114 of the apparatus 100 may include various ports such as instrument or sensor connections, USB ports, power supply ports, and other auxiliary ports, such as additional communication ports/interfaces. The housing 102 of the apparatus 100 further includes a top face 118 and a bottom face 120 extending between the left side face 112 and the right side face 114.

The apparatus 100 further includes one or more rotary knobs 302 disposed on the front face 104, particularly, adjacent to the left side face 112, of the housing 102. The rotary knobs 302 are configured to receive a second set of user inputs. In some embodiments, the rotary knobs 302 may be provided on the left side face 112. In some implementations, the rotary knobs 302 can be in the form of push buttons or scrolling buttons provided on the front face 104 or the side face of the housing 102 to receive the second set of user inputs. In some embodiments, the rotary knobs 302 can be a virtual knobs, built into the UI 108 of the apparatus. The second set of user inputs are received through a thumb of the user. The one or more rotary knobs 302 are configured to select a number between 0-9. As such, the plurality of buttons 202 and the one or more rotary knobs 302 are together configured to select a precise value of an operating parameter of the apparatus 100 while holding the apparatus 100 in one hand. Although the apparatus 100 is shown in FIG. 1 configured for left hand usage, the apparatus 100 can also be designed and manufactured such that the apparatus 100 can be configured for right hand usage by a user, with the flexible handle 116 and the rotary knobs 302 being located on the right side face 114.

The apparatus 100 can further include a plurality of buttons 202 disposed on the rear face 106 of the housing 102, as shown in FIG. 2, adjacent to the side face, particularly, the left side face 112. In some embodiments, the plurality of buttons 202 can include a first pair of buttons 202A disposed on the rear face 106 adjacent to a corner of the housing 102 defined by the left side face 112 and the top face 118 and a second pair of buttons 202B disposed on the rear face 106 adjacent to a corner of the housing 102 defined by the left side face 112 and the bottom face 120. In one embodiment, the first pair of buttons 202A is integrated into a first push button. The first pair of buttons 202A can include an increasing value button 202Ai and a decreasing value button 202Ad. The increasing value button 202Ai can be configured to increase digit values of a bit by a single digit value when pressed once. The decreasing value button 202Ad can be configured to decrease digit values of a bit by a single digit value when pressed once. In some embodiments, the first push button may be defined as an elongated push button having both ends provided with each of the first pair of buttons 202A such that each of the first pair of buttons 202A is independently operated. Similarly, the second pair of buttons 202B can be integrated into a second push button. Similarly to as described above, although the apparatus 100 is shown in FIG. 1 configured for left hand usage, the apparatus 100 can also be designed and manufactured such that the apparatus 100 can be configured for right hand usage by a user. In this embodiment the first pair of buttons 202A can be disposed on the rear face 106 adjacent to a corner of the housing 102 defined by the right side face 114 and the top face 118 and a second pair of buttons 202B disposed on the rear face 106 adjacent to a corner of the housing 102 defined by the right side face 114 and the bottom face 120.

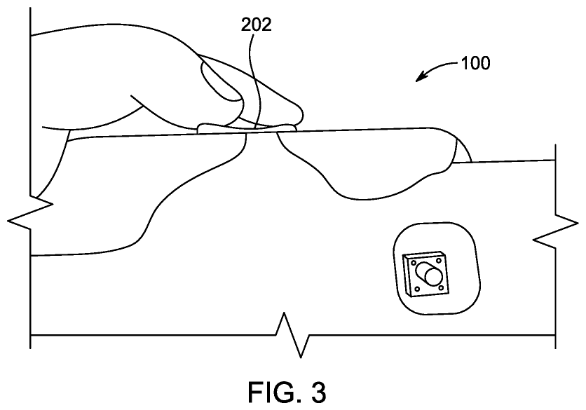

The plurality of buttons 202 are configured to receive a first set of user inputs. More particularly, each of the plurality of buttons 202 is configured to receive the first set of user inputs through a forefinger of the user, as shown in FIG. 3. While performing the NDT, the user may hold the apparatus 100 by inserting the fingers through the flexible handle 116. The plurality of buttons 202, particularly, for example, the first push button can be disposed on the rear face 106 of the housing 102 such that the forefinger of the user may be conveniently and comfortably used for operating the first push button. In some implementation of the present disclosure, the apparatus 100 may include one push button disposed on the rear face 106 adjacent to the corner of the housing 102 defined by the left side face 112 and the top face 118 such that the forefinger of the user may be conveniently used to repeatedly use the push button.

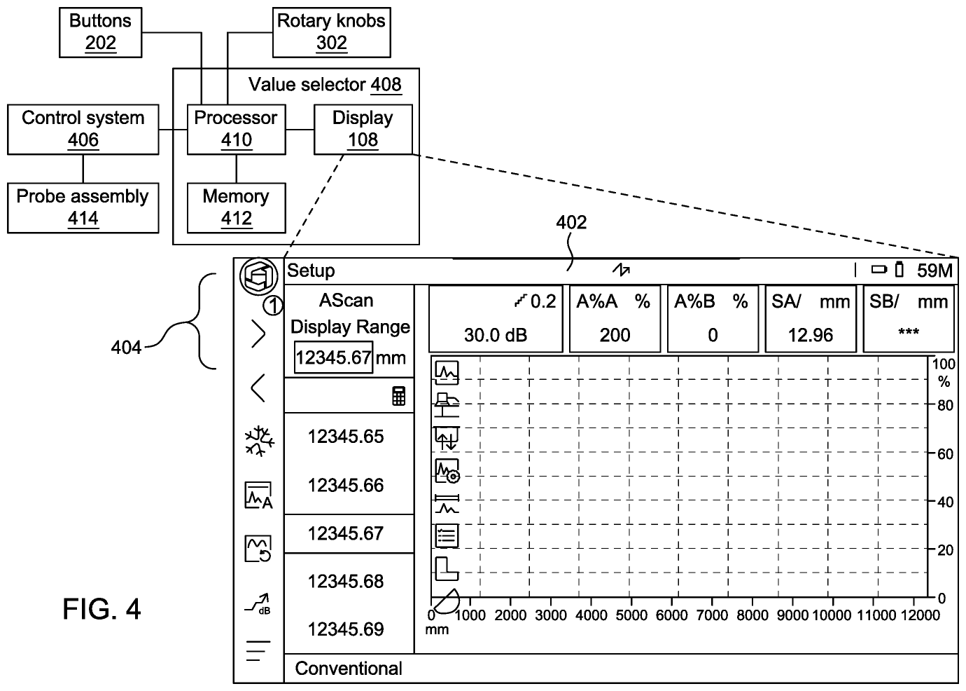

In an exemplary embodiment, as shown in FIG. 4, a display page 402 of the user interface 110 of apparatus 100 is illustrated. The display page 402 may include a value panel 404 to display a testing parameter, otherwise known as the operating parameter, and a numerical value corresponding to the testing parameter. In an embodiment, the user interface 110 of the apparatus 100 can be associated with a computing system which includes a control system 406. The control system 406 can be in communication with a value selector 408 having a processor 410 and a memory 412. The processor 410 may be in communication with input devices such as the plurality of buttons 202 and the one or more rotary knobs 302 such that the processor 410 can be configured to receive the first set of user inputs and the second set of user inputs, respectively. Further, the processor 410 can be configured to receive user inputs such as the testing parameters and the numerical values associated with the testing parameters. The processor 410 may include computer-readable and executable instructions, which when executed, perform processing associated with the testing such as transmitting instructions to the control system 406 or receiving data from the control system 406. The memory 412 may include non-transitory computer readable instructions which when executed cause the processor 410 to perform operations to determine the precise value of the testing parameter from the large range of values. The control system 406 may also be in communication with a probe assembly 414 that is used for sending and receiving signals with respect to an object upon which the NDT is being performed.

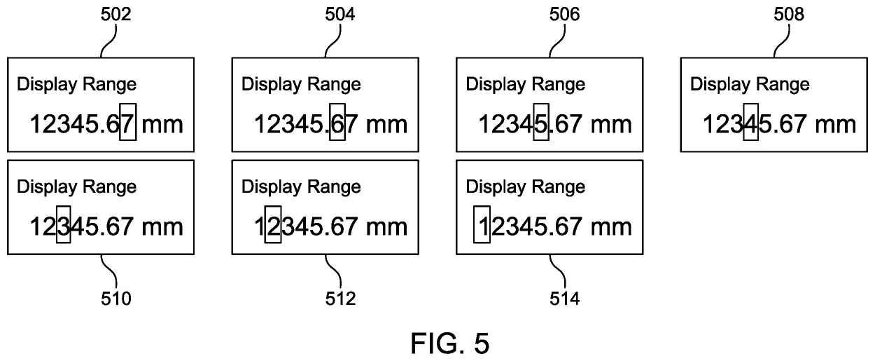

In an example, as shown in FIG. 4, a testing parameter value 12345.67 is displayed in the value panel 404. To precisely select a desired parameter value, one of the plurality of buttons 202 is clicked once such that a first bit of the number is selected as shown in a first inset image 502 of FIG. 5. Particularly, the first bit of the number displayed on the user interface 110 corresponds to a first click by the user. As shown in the first inset image 502, the first bit, represented by the number 7, is selected upon clicking the button 202 once using the forefinger of the user. After selecting the first bit, the rotary knob 302 may be used to select a number between 0-9 such that a desired number between 0-9 may be selected to place the selected number in the place of first bit. The processor 410 in communication with the buttons 202 and the rotary knobs 302 may determine the desired bit and the desired number. As shown in a second inset image 504, the button 202 is clicked twice to select a second bit. Upon selecting the second bit, the rotary knob 302 may be used to select a desired number between 0-9. Similarly, as shown in inset images 506, 508, 510, 512, and 514, the button 202 may be clicked three times to select a third bit, four times to select a fourth bit, five times to select a fifth bit, six times to select a sixth bit, and seven times to select seventh bit, respectively. As such, each of the plurality of buttons 202 is configured to select an n^{th} bit in the number corresponding to an n^{th} click by the user. Thus, the plurality of buttons 202 and the one or more rotary knobs 302 are together configured to help the user to select the precise value of the operating parameter of the apparatus 100 conveniently and comfortably.

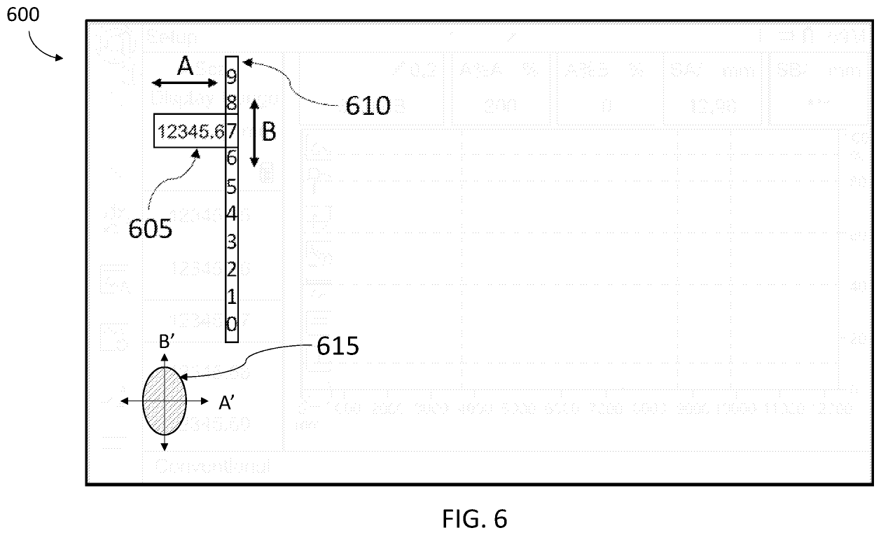

FIG. 6 illustrates an exemplary display page 600 showing a number 605 selected from a value panel of the user interface 110 of apparatus 100 (e.g, value panel 404 of FIG. 4). In some embodiments, the number 605 can correspond to a testing parameter, as described above. In the embodiment illustrated, the user interface 110 can be a touch screen and a user can precisely select the number 605 by touching the number 605 on the display page 600, for example, with the user's thumb. Once the number 605 is selected, the display page 600 can be configured to display a virtual knob 610 within the user interface 110. As shown in FIG. 6, the number 605 can include a plurality of bits ranging from a first bit, represented by the number 7, to a seventh bit, represented by the number 1. In the present embodiment, the user can select a bit of the number 605 by sliding the virtual knob 610 back and forth along a direction A with the user's thumb. After selecting bit (e.g., the first bit, as shown), the user can select a number between 0-9 to place in the place of first bit, by rotating the virtual knob 610 back and forth along a direction B with the user's thumb. In some embodiments, the thumb of the user does not need to be in direct contact with the virtual knob 610 in order to select a bit of the number 605 and/or a number between 0-9 to place in the place of selected bit. For example, in some embodiments, once the number 605 is selected by the user, and the virtual knob 610 is displayed on the display page 600, the user can place their thumb in contact with the user interface 110 at a location 615, remote from the virtual knob 610. Once the user places their thumb at the location 625, the user can select a bit of the number 605 by sliding their thumb back and forth along a direction A′, and can select a number between 0-9 to place in the place of first bit, by sliding their thumb back and forth along a direction B′. The processor of the apparatus (e.g., processor 410) can determine the desired bit and the desired number from the placement of the virtual knob 610. Thus, the virtual knob 610 is configured to help the user to select the precise value of the number 605 conveniently and comfortably.

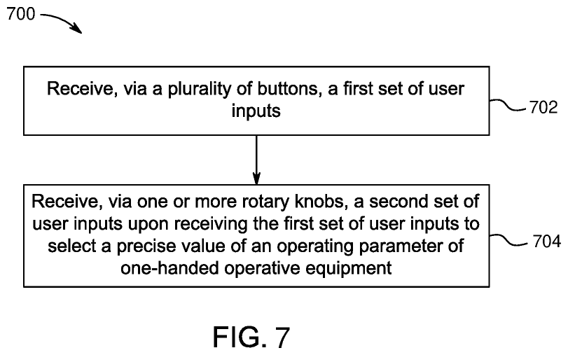

FIG. 7 is a flow diagram illustrating a method 700 of selecting numbers in the one-handed operative equipment, such as the apparatus 100 shown and described in relation to FIG. 1. The method 700 can be performed by one or more components of the one-handed operative equipment 100. In some embodiments, the method 700 can be performed by the control system and the processor of the one-handed operative equipment 100.

At 702, the method 700 includes receiving the first set of user inputs via the plurality of buttons 202 disposed on the rear face 106 of the housing 102. While performing the test, the user will hold the one-handed operative equipment 100 by inserting the fingers though the flexible handle 116 and the forefinger of the user is used to operate the buttons 202. In some embodiments, the first bit of the number displayed on the value panel 404 of the user interface 110 may be selected by clicking the button 202 once. In other words, the first bit of the number may correspond to the first click of the button 202. Similarly, the n^{th} bit in the number may correspond to the n^{th} click of the button 202 by the user.

At 704, the method 700 includes receiving the second set of user inputs via the one or more rotary knobs 302 upon receiving the first set of user inputs to select the precise value of the operating parameter of the one-handed operative equipment 100. The second set of user inputs is provided to the one or more rotary knobs 302 using the thumb of the user. Particularly, the method 700 includes selecting the number between 0-9 using the rotary knob 302 after selecting the bit such that the precise number is selected in the one-handed operative equipment 100 without much effort.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. An apparatus comprising:
a housing having a front face and a rear face, wherein the front face is configured to display a user interface;
a plurality of first buttons disposed on the rear face of the housing adjacent to a side face, and configured to receive a first set of user inputs from a user; and
one or more second buttons configured to receive a second set of user inputs from the user,
wherein the first set of user inputs and the second set of user inputs are received via a forefinger and a thumb, respectively, of the user, and
wherein the plurality of first buttons and the one or more second buttons are together configured to select a precise value of an operating parameter of the apparatus.

2. The apparatus of claim 1, wherein the plurality of first buttons comprises a first pair of buttons disposed on the rear face adjacent to a corner of the housing defined by the side face and a top face.

3. The apparatus of claim 1, wherein the plurality of first buttons comprises a second pair of buttons disposed on the rear face adjacent to a corner of the housing defined by the side face and a bottom face.

4. The apparatus of claim 2, wherein the first pair of buttons is integrated into a first push button.

5. The apparatus of claim 3, wherein the second pair of buttons is integrated into a second push button.

6. The apparatus of claim 1, wherein the one or more second buttons comprises a third pair of buttons disposed on the front face of the housing.

7. The apparatus of claim 1, wherein the one or more second buttons comprises a rotary knob disposed on the front face of the housing.

8. The apparatus of claim 1, wherein the one or more second buttons comprises a virtual knob integrated within the user interface.

9. The apparatus of claim 1, wherein each of the plurality of first buttons is configured to:
select a first bit in a number displayed on the user interface corresponding to a first click by the user; and
select an n^{th} bit in the number corresponding to an n^{th} click by the user.

10. The apparatus of claim 9, wherein the one or more second buttons are configured to select a number between 0-9 after selecting the first bit or the n^{th} bit in the number.

11. A method comprising:
receiving, via a plurality of first buttons provided on a one-handed operative NDT instrument, a first set of user inputs, wherein the one-handed operative NDT instrument comprises a front face displaying a user interface and a rear face supporting the plurality of buttons, and wherein the plurality of buttons receives inputs from a forefinger of a user; and
receiving, via one or more second buttons, a second set of user inputs upon receiving the first set of user inputs, to select a precise value of an operating parameter of the one-handed operative NDT instrument, wherein the one or more second buttons are supported on the one-handed operative NDT instrument, and receive inputs from a thumb of the user.

12. The method of claim 11, wherein the plurality of first buttons comprises a first pair of buttons disposed on the rear face adjacent to a corner of the housing defined by the side face and a top face of the one-handed operative NDT instrument.

13. The method of claim 11, wherein the plurality of first buttons comprises a second pair of buttons disposed on the rear face adjacent to a corner of the housing defined by the side face and a bottom face of the one-handed operative NDT instrument.

14. The method of claim 12, wherein the first pair of buttons is integrated into a first push button.

15. The method of claim 13, wherein the second pair of buttons is integrated into a second push button.

16. The method of claim 11, wherein the one or more second buttons comprises a third pair of buttons disposed on the front face of the housing.

17. The method of claim 11, wherein the one or more second buttons comprises a rotary knob disposed on the front face of the housing.

18. The method of claim 11, wherein the one or more second buttons comprises a virtual knob integrated within the user interface.

19. The method of claim 11 further comprising:
selecting a first bit in a number displayed on the user interface corresponding to a first click by the user; and
selecting a n^{th} bit in the number corresponding to an n^{th} click by the user.

20. The method of claim 19 further comprising, selecting, via the one or more second buttons, a number between 0-9 after selecting the first bit and/or the n^{th} bit in the number.
